(19) United States
(12) Patent Application Publication
(10) Pub. No.: US 2005/0260303 A1
(43) Pub. Date: Nov. 24, 2005

(54) Sports drink

(76) Inventor: Daniel L. Tritch, Fort Wayne, IN (US)

Correspondence Address: BAKER & DANIELS LLP;111 E. WAYNE STREET, SUITE 800, FORT WAYNE, IN, 46802, US

(21) Appl. No.: 11/065,650

(22) Filed: Feb. 24, 2005

Related U.S. Application Data
(60) Provisional application No. 60/551,278, filed on Mar. 8, 2004.
(60) Provisional application No. 60/623,026, filed on Oct. 28, 2004.

(51) Int. Cl. A23K 1/175

(52) U.S. Cl. 426/74

(57) ABSTRACT

A conventional food in the form of a sports drink which contains quinine for preventing muscle cramping in athletes who undertake strenuous physical activity. In one form, the sports drink is a water-based composition which includes quinine as a muscle cramping preventative, as well as suitable electrolytes, such as potassium, calcium, sodium, and one or more flavoring agents for palatability. The sports drink also includes magnesium and/or calcium to enhance the muscle cramping preventative effects of quinine. The sports drink may also include carbohydrates, vitamins, minerals, amino acids, and other nutrients as desired, and may have an acidic or substantially neutral pH. When consumed prior to, during, or after undertaking physical activity, the sports drink has been observed to be effective in preventing muscle cramping, or alleviating muscle cramping once it has occurred.

### CROSS REFERENCE TO RELATED APPLICATIONS

This application is related to and claims the benefit under Title 35, U.S.C. § 119(e) of U.S. Provisional Patent Application Ser. No. 60/551,278, entitled SPORTS DRINK, filed on Mar. 8, 2004, as well as U.S. Provisional Patent Application Ser. No. 60/623,026, entitled SPORTS DRINK, filed on Oct. 28, 2004.

### BACKGROUND OF THE INVENTION

1. Field of the Invention

The present invention relates to sports drinks of the type consumed by athletes before, during, or after engaging in strenuous physical activity, such as exercise, training, and athletic competition.

2. Description of the Related Art

It is well known that athletes, when undertaking strenuous physical activity during exercise, training, or competition, will lose bodily fluids through sweating according to the human body's natural cooling process. In particular, athletes lose water, electrolytes, sugars, minerals, vitamins, amino acids, and other nutrients through sweating during physical activity. In order to replace the water, electrolytes, and other nutrients which are lost through sweat during exercise, athletes typically consume water and/or sports drinks before, during, or after undertaking physical activity. Known sports drinks are usually water-based, and typically include electrolytes such as potassium, sodium, and calcium, as well as sugars, vitamins, amino acids, minerals, and other nutrients, as well as flavoring agents.

Additionally, it is well known that athletes may exhibit muscular cramping during strenuous activity, particularly in the lower extremities and particularly when the ambient temperature is high. Other risk factors for muscle cramping include poor diet and high body weight. Leg cramping in particular is often observed in athletes who undertake a significant amount of running and/or jumping activities, such as during participation in track, basketball, and football, for example. In both individual and team sports, muscle cramping can adversely effect the outcome of competitions for athletes and/or their teams.

While the exact physiological causes of muscle cramping are not completely understood, one theory is that muscle fatigue may interfere with the neurological mechanisms which control muscle contraction. Another theory is that muscle cramping results from dehydration, and in particular, electrolyte loss during sweating which occurs during strenuous physical activity.

The latter of the foregoing theories is rather long standing, and is known to many athletes. Thus, athletes who frequently undertake strenuous physical activity in training and competition often drink water or sports drinks before, during, or after physical exertion in an attempt to prevent muscle cramping. Additionally, athletes also typically perform stretching exercises before physical activity in an attempt to prevent cramping. However, in spite of the athletes' efforts to remain hydrated and to stretch before physical activity, muscle cramping is still often observed, and can occur seemingly randomly in all types of athletes participating in all types of physical activity.

Quinine is a known muscle relaxant, and has been prescribed by physicians for the treatment of nocturnal cramping in the elderly, usually in the form of its quinine sulfate salt, at high doses such as 300 or 325 mg., for example. In the 1600's and 1700's, quinine was believed to have anti-malarial benefits, and was included in tonic water for administering orally, often mixed with gin. Today, tonic water still includes quinine; however, the very bitter taste of quinine makes it unpalatable to many people.

U.S. Pat. Nos. 5,891,888 and 6,039,987 to Strahl disclose physical endurance drinks which include quinine in relatively high amounts, namely, between 5 mg to 20 mg per 8 oz. Disadvantageously, the high amounts of quinine in the drinks, which are apparently considered necessary to achieve an anti-cramping effect, provide a bitter taste. In an attempt to mask the bitter taste of the quinine when present in such high amounts, the drinks include flavoring agents and have an acidic pH, namely, between 2.5 and 4.5, preferably 2.5.

What is needed is an improved, palatable sports drink which aids in preventing muscle cramping in athletes who undertake strenuous physical activity.

### SUMMARY OF THE INVENTION

The present invention relates to a conventional food in the form of a sports drink which contains quinine for preventing muscle cramping in athletes who undertake strenuous physical activity. In one form, the sports drink is a water-based composition which includes quinine as a muscle cramping preventative, as well as suitable electrolytes, such as potassium, calcium, sodium, and one or more flavoring agents for palatability. The sports drink also includes magnesium and/or calcium to enhance the muscle cramping preventative effects of quinine. The sports drink may also include carbohydrates, vitamins, minerals, amino acids, and other nutrients as desired, and may have an acidic or substantially neutral pH. When consumed prior to, during, or after undertaking physical activity, the sports drink has been observed to be effective in preventing muscle cramping, or alleviating muscle cramping once it has occurred.

In one embodiment, a sports drink is provided, including water, quinine and magnesium as muscle cramping preventatives, one or more electrolytes, such as potassium, and sodium, suitable suspension and/or flavoring agents, and optionally sugars and/or salt. It has been found that relatively low amounts of quinine, such as between 0.5 and 5 mg per 8 oz, are effective to prevent muscle cramps, yet do not adversely affect the palatability of the sports drink. Also, it is thought that the presence of magnesium and/or calcium in the sports drink, along with quinine, enhances the cramping preventative effect.

In one method, the sports drink is prepared by first preparing a liquid or solid concentrate composition including quinine and other ingredients, and thereafter diluting and mixing an amount of the concentrate with water, or a solution of water and electrolytes and/or other ingredients to form a ready-to-drink liquid sports drink. Alternatively, the sports drink may be produced directly in ready-to-drink liquid form. The sports drink may optionally be carbonated.

In one form thereof, the present invention provides a liquid composition for use as a sports drink, including water; at least one electrolyte; and quinine, in an amount of between 0.5 and 4.5 mg/8 oz.

In another form thereof, the present invention provides a liquid composition for use as a sports drink, including water; quinine; and magnesium, in an amount of between 0.5 and 25 mg/8 oz.

In another form thereof, the present invention provides a liquid composition for use as a sports drink, including water; quinine; and calcium, in an amount of between 0.5 and 25 mg/8 oz.

In a further form thereof, the present invention provides a liquid composition for use as a sports drink, including water; at least one electrolyte; quinine; and the composition having a pH of between 5.0 and 7.5.

### DETAILED DESCRIPTION

The disclosures of U.S. Provisional Patent Application Ser. No. 60/551,278, entitled SPORTS DRINK, filed on Mar. 8, 2004, as well as U.S. Provisional Patent Application Ser. No. 60/623,026, entitled SPORTS DRINK, filed on Oct. 28, 2004, are hereby incorporated by reference.

The present invention is directed toward a sports drink which includes quinine for preventing the occurrence of muscle cramping in athletes who consume the sports drink, or for aiding in alleviating muscle cramping once it has occurred. The sports drink may be prepared as a liquid composition ready for drinking, or alternatively, may be prepared in a liquid or powder concentrate form for mixing with water to form a liquid composition ready for drinking.

Although the physiological mechanism by which quinine prevents and/or alleviates muscle cramping is not completely understood, it is thought that the antimytonic activity of quinine acts upon the muscle fibers to increase the contractile refractory period, and that quinine aids in electrolyte distribution through the muscle fibers, allowing effective prevention and relief of muscle cramps. Additionally, quinine is water soluble, and is readily absorbed from the gastrointestinal tract.

In order to produce the sports drink, quinine ((C₂₀H₂₄N₂O₂)₂) (MW 324.18) is obtained from a suitable source, such as in bulk powder form or in tablet form as quinine sulfate ((C₂₀H₂₄N₂O₂)₂·H₂SO₄·2H₂O) (MW 782.95). The quinine sulfate may be mixed with water to dissolve the quinine sulfate, or alternatively, the quinine sulfate may be mixed with a suitable suspending agent, such as those set forth in the Examples herein. The suspending agent is effective to promote dispersion of the quinine sulfate in an aqueous medium.

The quinine content of the sports drink may at least 0.5 mg per 8 oz ((2.1 ppm), at least 1.5 mg per 8 oz (6.25 ppm), or at least 2.5 mg per 8 oz (10.42 ppm), and less than or equal to 100 mg per 8 oz 416.6 ppm), less than or equal to 10 mg per 8 oz (41.6 ppm), or less than or equal to 3.5 mg per 8 oz (14.59 ppm). Preferably, the quinine content will be between 0.5 and 4.5 mg per 8 oz, most preferably between 1.0 and 4.0 mg per 8 oz.

One or more flavoring agents may be used to mask the bitter taste of the quinine, such as cocoa, cherry, raspberry, cinnamon, lime, cola, citric acid, or other types of flavoring agents, typically available in the form of concentrated syrups. Specific flavoring agents are set forth in the Examples, and include lemon juice and lime juice. Further, commercially available packets of solid or powder form drink flavoring concentrate may also be added. Also, sugar or salt may be added as desired to aid in masking the bitter taste of the quinine. Suitable sugars include carbohydrate monomers and polymers, such as monosaccharides and oligosaccharides, including glucose and fructose.

The sports drink may also include one or more electrolytes, including in particular magnesium, which is thought to be a muscle cramping preventative. In particular, magnesium is though to enhance the anti-cramping effects of the quinine in the present sports drink by helping to stabilize muscle membranes, in view of the fact that magnesium has been used in the past to relieve eclampsia convulsions during pregnancy. The sports drink may have a magnesium content of at least 0.5 mg per 8 oz (2.1 ppm), at least 1.5 mg per 8 oz (6.25 ppm), or at least 2.5 mg per 8 oz (10.42 ppm), and less than or equal to 25 mg per 8 oz (104.17 ppm), less than or equal to 12.5 mg per 8 oz (52 ppm), or less than or equal to 5 mg per 8 oz (20.84 ppm).

The sports drink may include one or more additional electrolytes, such as alkali and alkaline earth salts, including salts of potassium, calcium, magnesium, or sodium such as, for example, sodium chloride, sodium acetate, sodium citrate, sodium bromide, sodium phosphate, potassium acetate, potassium bromide, potassium chloride, potassium citrate, calcium acetate, calcium chloride, calcium phosphate, and magnesium chloride.

Calcium is also thought to be a muscle cramping preventative. In particular, calcium has been used in the past in the treatment of seizure-induced cramping, and is also though to enhance the anti-cramping effects of the quinine in the present sports drink. The calcium content of the sports drink may be at least 0.5 mg per 8 oz (2.1 ppm), at least 1.5 mg per 8 oz (6.25 ppm), or at least 2.5 mg per 8 oz (10.42 ppm), and less than or equal to 25 mg per 8 oz (104.17 ppm), less than or equal to 12.5 mg per 8 oz (52 ppm), or less than or equal to 5 mg per 8 oz (20.84 ppm).

To improve the palatability of the sports drink, the pH of the sports drink is substantially acidic or substantially neutral. In particular, the pH of the sports drink may be as low as 2.5, 3.5, 4.5 or 5.0, or as high as 7.5, 7.0, 6.5, or 6.0.

The present sports drink may be carbonated, if desired, although it is preferred that the sports drink not be carbonated in order to make the drink easier to consume.

According to one embodiment, between 8 oz and 16 oz of the sports drink, for example, may be consumed by the athlete about 1 to 2 hours before physical activity and/or during physical activity.

These and other aspects of the present invention may be more readily understood by reference to one or more of the following Examples. In the following Examples, sports drink servings of 8, 10, and 16 ounces are used, wherein ounces indicated are fluid ounces. However, one of ordinary skill in the art will appreciate that the amounts of the various components of the sports drink may be modified to form different volume servings of the sports drink, such as 6 ounces or 12 ounces, for example, by application of suitable dilution or concentration factors.

### EXAMPLE 1

### Sports Drink Formulation

A sports drink concentrate was made, including the following ingredients:

| Ingredient | Amount | |
|---|---|---|
| Quinine sulfate, five (5) 324 mg capsules | 1620 | mg |
| Ora Sweet (simple syrup), NDC | 70 | ml |
| 00574-0304-16, available from Paddock Co., | | |
| Minneapolis, MN | | |
| Ora-Plus (oral suspending agent), NDC | 90 | ml |
| 00574-0303 from Paddock Co., Minneapolis,MN | | |
| Cherry syrup (flavoring vehicle), NDC | 20 | ml |
| 00395-2662-16, available from Humco Labs | | |
| in Texarkana, TX | | |

The concentrate was prepared as follows. First, 90 ml of Ora-Plus suspending agent was measured into a container, followed by dissolving the contents of five (5) 324 mg capsules of quinine sulfate into the suspending agent with mixing. Thereafter, 70 ml of Ora Sweet and 20 ml of cherry flavoring agent was measured and combined with the suspending agent and quinine sulfate with mixing until a homogeneous concentrate solution was obtained having a total volume of 180 ml.

Then, 2.2 ml portions of the concentrate solution were added via pipette, each to an 8 ounce bottle of fruit punch flavored Gatorade® sports drink. (Gatorade® is a registered trademark of Stokely-Van Camp, Inc. of Chicago, Ill.). Gatorade® is a commercially available non-carbonated sports drink, which includes a mixture of water, sodium chloride, potassium chloride, flavoring agents, and other ingredients. Each 2.2 ml portion of the concentrate solution contained approximately 20 mg quinine sulfate, thus, each eight ounce portion of sports drink included 20 mg of quinine sulfate.

### EXAMPLE 2

### Muscle Cramping Study #1

In order to observe the effects of the present sports drink on muscle cramping in athletes, a study was conducted with high school football players as described below. Over a three week time frame, 4 athletic trainers covering 5 different high schools participated in the study. Each trainer randomly chose 10 athletes for each of two high school football games. Consent forms outlining the study were signed by the athletes' guardians and recorded by the attending athletic trainer.

At each of 10 total games, 5 athletes were selected at random to receive the present sports drink of EXAMPLE 1, containing quinine sulfate, and 5 athletes were selected to receive a control drink of fruit punch flavored Gatorade® without the quinine sulfate concentration of EXAMPLE 1. The athletes were instructed to drink the entire contents of the drink at least 30 minutes prior to participation in the football game. Each athlete was asked to complete a survey within 30 minutes of the completion of the game, which survey asked the athlete a series of questions regarding the occurrence of muscle cramping during the game. A total of 26 athletes in the study group complied with the consumption and survey requirements, and a total of 20 athletes in the control group complied with the consumption and survey requirements.

Of the 26 athletes in the study group, an average of 40.8 minutes of play time was reported, while the average play time reported for 20 athletes in the control group was 36.8 minutes. The average temperature at the games was 72° F.

Two (2) members of the study group reporting muscle cramping during the games, with the severity of the cramping averaging 1.5 out of 10 on a subjective pain scale rating, as reported by the survey. Six (6) members of the control group reported muscle cramping during the games with the severity of the cramping averaging 3.5 out of 10 on the subjective pain scale rating, as reported by the survey. No members of the study group experienced more than one muscle cramp each competition, and no muscle cramps which were experienced during the competitions prohibited participation in the competition by the respective athlete.

The athletes in the control group reported an average of 1.83 muscle cramps per athlete, with 2 athletes reporting 1 muscle cramp, 3 athletes reporting 2 muscle cramps, and 1 athlete reporting 3 muscle cramps. All athletes in the control group who experienced more than 1 episode of muscle cramping during any given competition had play time shortened because of the cramping episodes.

The foregoing study indicates that consumption of the present sports drink is beneficial in reducing cramping in athletes during strenuous physical activity.

### EXAMPLE 3

### Sports Drink Formulation

A sports drink concentrate was made, including the following ingredients:

| Ingredient | Amount | |
|---|---|---|
| Quinine sulfate, five (5) 324 mg capsules | 1620 | mg |
| NDC 53489-0221-01, available from Mutual | | |
| Labs, Philadelphia, PA | | |
| Ora Sweet (simple syrup), NDC | 60 | ml |
| 00574-0304-16, available from Paddock Co., | | |
| Minneapolis, MN | | |
| Ora-Plus (oral suspending agent vehicle), | 40 | ml |
| NDC 00574-0303, available from Paddock | | |
| Co., Minneapolis, MN | | |
| Cherry syrup (flavoring vehicle), NDC | 60 | ml |
| 00395-2662-16, available from Humco Labs | | |
| in Texarkana, TX | | |
| Water (filtered osmosis) | 20 | ml |

The concentrate was prepared as follows. First, the 5 capsules of quinine sulfate were added to 20 ml of water in a 180 ml liquid prescription bottle and shaken vigorously. Then, 40 ml of Ora-plus was added with shaking, followed by the addition of 60 ml of Ora-sweet with shaking. Finally, 60 ml of cherry syrup was added with shaking to make a final concentrate suspension of 180 ml.

A 1.1 ml portion of the quinine concentrate suspension, including 10 mg of quinine sulfate, was added to 10 ounces of fruit flavored Gatorade® sports drink. The drink had a slight bitter taste as tested by a test panel.

### EXAMPLE 4

### Sports Drink Formulation

A sports drink concentrate was made, including the following ingredients:

| Ingredient | Amount | |
|---|---|---|
| Quinine sulfate, five (5) 324 mg capsules | 1620 | mg |
| NDC 53489-0221-01, available from Mutual | | |
| Labs, Philadelphia, PA | | |
| Ora Sweet (simple syrup), NDC | 60 | ml |
| 00574-0304-16, available from Paddock Co., | | |
| Minneapolis, MN | | |
| Ora-Plus (oral suspending agent vehicle), | 40 | ml |
| NDC 00574-0303, available from Paddock | | |
| Co., Minneapolis, MN | | |
| Cherry syrup (flavoring vehicle), NDC | 60 | ml |
| 00395-2662-16, available from Humco Labs | | |
| in Texarkana, TX | | |
| Water (filtered osmosis) | 20 | ml |
| Morton's ® table salt - sodium chloride, | 2.75 | gm |
| calcium silicate, dextrose, and potassium | | |
| iodide, available from Morton Intl. Inc., | | |
| Chicago, IL | | |

The concentrate was prepared as follows. First, the 5 capsules of quinine sulfate were added to 20 ml of water in 180 ml of liquid prescription bottle and shaken vigorously. Then, 40 ml of Ora-plus was added with shaking, followed by the addition of 60 ml of Ora-sweet with shaking. 60 ml of cherry syrup were then added, along with 2.75 gm salt (approximately ½ teaspoon) and shaken very well to ensure that the salt crystals dissolved well into the concentrate suspension.

A 1.1 ml of the quinine sulfate suspension, including 10 mg of quinine sulfate, was added to 10 ounces of fruit flavored Gatorade® sports drink. The drink had a very slight quinine taste, as tested by a test panel. The test panel also found the drink to have a salty flavor.

### EXAMPLE 5

### Sports Drink Formulation

A sports drink concentrate was made, including the following ingredients:

| Ingredient | Amount | |
|---|---|---|
| Quinine sulfate, five (5) 324 mg capsules | 1620 | mg |
| NDC 53489-0221-01, available from Mutual | | |
| Labs, Philadelphia, PA | | |
| Ora-Sweet (simple syrup), NDC | 60 | ml |
| 00574-0304-16, available from Paddock Co., | | |
| Minneapolis, MN | | |
| Ora-Plus (oral suspending agent vehicle), | 40 | ml |
| NDC 00574-0303, available from Paddock | | |
| Co., Minneapolis, MN | | |
| Cherry syrup (flavoring vehicle), NDC | 60 | ml |
| 00395-2662-16, available from Humco Labs | | |
| in Texarkana, TX | | |
| Water (filtered osmosis) | 20 | ml |
| Morton's ® table salt - sodium chloride, | 0.75 | gm |
| calcium silicate, dextrose, and potassium | | |
| iodide, available from Morton Intl. Inc., | | |
| Chicago, IL | | |

The concentrate was prepared as follows. First, the 5 capsules of quinine sulfate were added to 20 ml of water in a 180 ml liquid prescription bottle and shaken vigorously. 40 ml of Ora-plus was added with shaking, followed by the addition of 60 ml of Ora-sweet with shaking. 60 ml of cherry syrup was added, along with 0.75 gm of salt (approx. ⅙ of a teaspoon), and shaken very well to ensure that the salt crystals dissolved.

A 1.1 ml portion of the quinine sulfate suspension, including 10 mg of quinine sulfate, was added to 10 ounces of fruit flavored Gatorade® sports drink. A 0.55 ml portion of the quinine sulfate suspension, including 5 mg of quinine sulfate, was added to 10 ounces of fruit flavored Gatorade® sports drink. A very slightly noticeable taste of quinine was present in drinks, and the lower concentration of salt enhanced the masking of the bitter taste of the quinine. There was no noticeable bitter aftertaste of quinine after taste testing the drink by the members of the test panel.

### EXAMPLE 6

### Sports Drink Formulation

A sports drink concentrate was made, including the following ingredients:

| Ingredient | Amount | |
|---|---|---|
| Quinine sulfate, five (5) 324 mg capsules | 1620 | mg |
| NDC 53489-0221-01, available from Mutual | | |
| Labs, Philadelphia, PA | | |
| Morton's ® table salt, sodium chloride, | 0.75 | gm |
| calcium silicate, dextrose, and potassium | | |
| iodide, available from Morton Intl. Inc., | | |
| Chicago, IL | | |
| Lime concentrate, Realime ® 100% juice, | 52 | ml |
| available from Molt's of Stanford, CT | | |
| Water (filtered osmosis) | 20 | ml |

The concentrate was prepared as follows. First, the two 324 mg capsules of quinine sulfate were added to 20 ml of water in a 90 ml prescription bottle and shaken well. Next, 52 ml of lime concentrate was added, along with 0.50 mg of salt, and shaken well.

A 1.1 ml portion of the quinine sulfate suspension, including 10 mg of quinine sulfate, was added to 8 ounces of fruit flavored Gatorade® sports drink. The bitter taste of quinine was present, as tested by the test panel, and the lime flavor did not mix with the fruit flavor of the Gatorade® from a flavor standpoint.

### EXAMPLE 7

### Sports Drink Formulation

A sports drink concentrate was made, including the following ingredients:

| Ingredient | Amount | |
|---|---|---|
| Quinine sulfate, from 5 capsules (325 mg), | 1620 | mg |
| NDC 53489-0021-01, available from Mutual | | |
| Labs, Philadelphia, PA 19124 | | |
| Potassium chloride, 20% (SF) liq., NDC | 17 | ml |
| 00472-1001-16, available from Alphaderm | | |
| USPD Inc., Baltimore, MD 21244 | | |
| Calcium chloride (injection), USP 10%, | 10 | ml |
| NDC 0517-2710-25, available from | | |
| American Regent Laboratories, Inc., Shirley, | | |
| NY 11967 | | |
| Magnesium oxide, 4 tablets (400 mg. ea), | 1600 | mg |
| NDC 68585-0006-12, available from Rising | | |
| Pharmaceuticals, Inc., Paramus, NJ | | |
| Ora-plus (oral suspending agent), NDC | 15 | ml |
| 00574-0303-16, available from Paddock Co., | | |
| Minneapolis, MN 55427 | | |
| Cherry syrup (flavoring vehicle), NDC | 120 | ml |
| 00395-2662-16, available from Humco Labs, | | |
| Texarkana, TX 75501 | | |
| Water (filtered osmosis) | 18 | ml |
| Sodium chloride (table salt) | ¼ | tsp |
| Total Volume of Concentrate | 180 | ml |

The concentrate was prepared as follows. 5 capsules of quinine sulfate were emptied into a 150 ml amber prescription bottle and the gelatine caps of the capsules were discarded. 4 magnesium oxide tablets (400 mg) were crushed and combined with the quinine sulfate. 18 ml of filtered water was added, along with 15 ml Ora-Plus suspending agent and the mixture was shaken vigorously for 2 min. Then, 17 ml potassium chloride was added, along with 10 ml of calcium chloride and the mixture was shaken well for 2 min. Then, 120 of cherry syrup and ¼ tsp of sodium chloride was added and the mixture was shaken well for 2 min.

gallon of sports drink was prepared from 4.4 ml of the concentrate by adding the following further ingredients to the concentrate:

| Ingredient | Amount | |
|---|---|---|
| Granulated sugar | 8 | oz |
| | (240 | ml) |
| Lemon juice concentrate (liquid) | 200 | ml |
| Lime juice concentrate (liquid) | 30 | ml |
| Sodium chloride (table salt) | ¾ | tsp |
| Water (filtered osmosis) | to make 1 | gallon |

The foregoing ingredients were added to the concentrate with mixing, followed by addition of the water to make 1 gallon of sports drink. The pH of the sports drink was 2.80. Thereafter, the sports drink was separated into individual 8 oz. portions or servings, each 8 oz. portion or serving including the following amounts of ingredients:

| Ingredient | Amount | |
|---|---|---|
| Quinine | 2.5 | mg |
| Potassium | 5 | mg |
| Calcium | 2.5 | mg |
| Magnesium | 3 | mg |
| Sodium | 55 | mg |

### EXAMPLE 8

### Sports Drink Formulation

A sports drink concentrate was made, including the following ingredients:

| Ingredient | Amount | |
|---|---|---|
| Quinine sulfate, from 6 capsules (325 mg), | 1950 | mg |
| NDC 53489-0021-01, available from Mutual | | |
| Labs, Philadelphia, PA 19124 | | |
| Potassium chloride, 20% (SF) liq., NDC | 17 | ml |
| 00472-1001-16, available from Alphaderm | | |
| USPD Inc., Baltimore, MD 21244 | | |
| Calcium chloride (injection), USP 10%, | 10 | ml |
| NDC 0517-2710-25, available from | | |
| American Regent Laboratories, Inc., Shirley, | | |
| NY 11967 | | |
| Magnesium oxide, 4 tablets (400 mg. ea), | 1600 | mg |
| NDC 68585-0006-12, available from Rising | | |
| Pharmaceuticals, Inc., Paramus, NJ | | |
| Ora-plus (oral suspending agent), NDC | 15 | ml |
| 00574-0303-16, available from Paddock Co., | | |
| Minneapolis, MN 55427 | | |
| Cherry syrup (flavoring vehicle), NDC | 120 | ml |
| 00395-2662-16, available from Humco Labs, | | |
| Texarkana, TX 75501 | | |
| Water (filtered osmosis) | 18 | ml |
| Sodium chloride (table salt) | ¼ | tsp |
| Total Volume of Concentrate | 180 | ml |

The concentrate was prepared as follows. 6 capsules of quinine sulfate were emptied into a 150 ml amber prescription bottle and the gelatine caps of the capsules were discarded. 4 magnesium oxide tablets (400 mg) were crushed and combined with the quinine sulfate. 18 ml of filtered water was added, along with 15 ml Ora-Plus suspending agent and the mixture was shaken vigorously for 2 min. Then, 17 ml potassium chloride was added, along with 10 ml of calcium chloride and the mixture was shaken well for 2 min. Then, 120 of cherry syrup and ¼ tsp of sodium chloride was added and the mixture was shaken well for 2 min.

1 gallon of sports drink was prepared from 4.4 ml of the concentrate by adding the following further ingredients to the concentrate:

| Ingredient | Amount | |
|---|---|---|
| Granulated sugar | 8 | oz |
| | (240 | ml) |
| Lemon juice concentrate (liquid) | 200 | ml |
| Lime juice concentrate (liquid) | 30 | ml |
| Sodium chloride (table salt) | ¾ | tsp |
| Water (filtered osmosis) | to make 1 | gallon |

The foregoing ingredients were added to the concentrate with mixing, followed by addition of the water to make 1 gallon of sports drink. The pH of the sports drink was 2.80. Thereafter, the sports drink was separated into individual 8 oz. portions or servings, each 8 oz. portion or serving including the following amounts of ingredients:

| Ingredient | Amount | |
|---|---|---|
| Quinine | 3 | mg |
| Potassium | 5 | mg |
| Calcium | 2.5 | mg |
| Magnesium | 3 | mg |
| Sodium | 55 | mg |

### EXAMPLE 9

### Sports Drink Formulation

A sports drink concentrate was made, including the following ingredients:

| Ingredient | Amount | |
|---|---|---|
| Quinine sulfate, from 7 capsules (325 mg), | 2275 | mg |
| NDC 53489-0021-01, available from Mutual | | |
| Labs, Philadelphia, PA 19124 | | |
| Potassium chloride, 20% (SF) liq., NDC | 17 | ml |
| 00472-1001-16, available from Alphaderm | | |
| USPD Inc., Baltimore, MD 21244 | | |
| Calcium chloride (injection), USP 10%, | 10 | ml |
| NDC 0517-2710-25, available from | | |
| American Regent Laboratories, Inc., Shirley, | | |
| NY 11967 | | |
| Magnesium oxide, 4 tablets (400 mg. ea), | 1600 | mg |
| NDC 68585-0006-12, available from Rising | | |
| Pharmaceuticals, Inc., Paramus, NJ | | |
| Ora-plus (oral suspending agent), NDC | 15 | ml |
| 00574-0303-16, available from Paddock Co., | | |
| Minneapolis, MN 55427 | | |
| Cherry syrup (flavoring vehicle), NDC | 120 | ml |
| 00395-2662-16, available from Humco Labs, | | |
| Texarkana, TX 75501 | | |
| Water (filtered osmosis) | 18 | ml |
| Sodium chloride (table salt) | ¼ | tsp |
| Total Volume of Concentrate | 180 | ml |

The concentrate was prepared as follows. 7 capsules of quinine sulfate were emptied into a 150 ml amber prescription bottle and the gelatine caps of the capsules were discarded. 4 magnesium oxide tablets (400 mg) were crushed and combined with the quinine sulfate. 18 ml of filtered water was added, along with 15 ml Ora-Plus suspending agent and the mixture was shaken vigorously for 2 min. Then, 17 ml potassium chloride was added, along with 10 ml of calcium chloride and the mixture was shaken well for 2 min. Then, 120 of cherry syrup and ¼ tsp of sodium chloride was added and the mixture was shaken well for 2 min.

1 gallon of sports drink was prepared from 4.4 ml of the concentrate by adding the following further ingredients to the concentrate:

| Ingredient | Amount | |
|---|---|---|
| Granulated sugar | 8 | oz |
| | (240 | ml) |
| Lemon juice concentrate (liquid) | 200 | ml |
| Lime juice concentrate (liquid) | 30 | ml |
| Sodium chloride (table salt) | ¾ | tsp |
| Water (filtered osmosis) | to make 1 | gallon |

The foregoing ingredients were added to the concentrate with mixing, followed by addition of the water to make 1 gallon of sports drink. The pH of the sports drink was 2.80. Thereafter, the sports drink was separated into individual 8 oz. portions or servings, each 8 oz. portion or serving including the following amounts of ingredients:

| Ingredient | Amount | |
|---|---|---|
| Quinine | 3.5 | mg |
| Potassium | 5 | mg |
| Calcium | 2.5 | mg |
| Magnesium | 3 | mg |
| Sodium | 55 | mg |

### EXAMPLE 10

### Sports Drink Formulation

A sports drink concentrate was made, including the following ingredients:

| Ingredient | Amount | |
|---|---|---|
| Quinine sulfate, from 4 capsules (325 mg), | 1300 | mg |
| NDC 53489-0021-01, available from Mutual | | |
| Labs, Philadelphia, PA 19124 | | |
| Potassium chloride, 20% (SF) liq., NDC | 17 | ml |
| 00472-1001-16, available from Alphaderm | | |
| USPD Inc., Baltimore, MD 21244 | | |
| Calcium chloride (injection), USP 10%, | 10 | ml |
| NDC 0517-2710-25, available from | | |
| American Regent Laboratories, Inc., Shirley, | | |
| NY 11967 | | |
| Magnesium oxide, 4 tablets (400 mg. ea), | 1600 | mg |
| NDC 68585-0006-12, available from Rising | | |
| Pharmaceuticals, Inc., Paramus, NJ | | |
| Ora-plus (oral suspending agent), NDC | 15 | ml |
| 00574-0303-16, available from Paddock Co., | | |
| Minneapolis, MN 55427 | | |
| Cherry syrup (flavoring vehicle), NDC | 120 | ml |
| 00395-2662-16, available from Humco Labs, | | |
| Texarkana, TX 75501 | | |
| Water (filtered osmosis) | 18 | ml |
| Sodium chloride (table salt) | ¼ | tsp |
| Total Volume of Concentrate | 180 | ml |

The concentrate was prepared as follows. 4 capsules of quinine sulfate were emptied into a 150 ml amber prescription bottle and the gelatine caps of the capsules were discarded. 4 magnesium oxide tablets (400 mg) were crushed and combined with the quinine sulfate. 18 ml of filtered water was added, along with 15 ml Ora-Plus suspending agent and the mixture was shaken vigorously for 2 min. Then, 17 ml potassium chloride was added, along with 10 ml of calcium chloride and the mixture was shaken well for 2 min. Then, 120 of cherry syrup and ¼ tsp of sodium chloride was added and the mixture was shaken well for 2 min.

1 gallon of sports drink was prepared from 4.4 ml of the concentrate by adding the following further ingredients to the concentrate:

| Ingredient | Amount | |
|---|---|---|
| Granulated sugar | 8 | oz |
| | (240 | ml) |
| Lemon juice concentrate (liquid) | 200 | ml |
| Lime juice concentrate (liquid) | 30 | ml |
| Sodium chloride (table salt) | ¾ | tsp |
| Water (filtered osmosis) | to make 1 | gallon |

The foregoing ingredients were added to the concentrate with mixing, followed by addition of the water to make 1 gallon of sports drink. The pH of the sports drink was 2.80. Thereafter, the sports drink was separated into individual 8 oz. portions or servings, each 8 oz. portion or serving including the following amounts of ingredients:

| Ingredient | Amount | |
|---|---|---|
| Quinine | 2 | mg |
| Potassium | 5 | mg |
| Calcium | 2.5 | mg |
| Magnesium | 3 | mg |
| Sodium | 55 | mg |

### EXAMPLE 11

### Sports Drink Formulation

A sports drink concentrate was made, including the following ingredients:

| Ingredient | Amount | |
|---|---|---|
| Quinine sulfate, from 3 capsules (325 mg), | 975 | mg |
| NDC 53489-0021-01, available from Mutual | | |
| Labs, Philadelphia, PA 19124 | | |
| Potassium chloride, 20% (SF) liq., NDC | 17 | ml |
| 00472-1001-16, available from Alphaderm | | |
| USPD Inc., Baltimore, MD 21244 | | |
| Calcium chloride (injection), USP 10%, | 10 | ml |
| NDC 0517-2710-25, available from | | |
| American Regent Laboratories, Inc., Shirley, | | |
| NY 11967 | | |
| Magnesium oxide, 4 tablets (400 mg. ea), | 1600 | mg |
| NDC 68585-0006-12, available from Rising | | |
| Pharmaceuticals, Inc., Paramus, NJ | | |
| Ora-plus (oral suspending agent), NDC | 15 | ml |
| 00574-0303-16, available from Paddock Co., | | |
| Minneapolis, MN 55427 | | |
| Cherry syrup (flavoring vehicle), NDC | 120 | ml |
| 00395-2662-16, available from Humco Labs, | | |
| Texarkana, TX 75501 | | |
| Water (filtered osmosis) | 18 | ml |
| Sodium chloride (table salt) | ¼ | tsp |
| Total Volume of Concentrate | 180 | ml |

The concentrate was prepared as follows. 3 capsules of quinine sulfate were emptied into a 150 ml amber prescription bottle and the gelatine caps of the capsules were discarded. 4 magnesium oxide tablets (400 mg) were crushed and combined with the quinine sulfate. 18 ml of filtered water was added, along with 15 ml Ora-Plus suspending agent and the mixture was shaken vigorously for 2 min. Then, 17 ml potassium chloride was added, along with 10 ml of calcium chloride and the mixture was shaken well for 2 min. Then, 120 of cherry syrup and ¼ tsp of sodium chloride was added and the mixture was shaken well for 2 min.

1 gallon of sports drink was prepared from 4.4 ml of the concentrate by adding the following further ingredients to the concentrate:

| Ingredient | Amount | |
|---|---|---|
| Granulated sugar | 8 | oz |
| | (240 | ml) |
| Lemon juice concentrate (liquid) | 200 | ml |
| Lime juice concentrate (liquid) | 30 | ml |
| Sodium chloride (table salt) | ¾ | tsp |
| Water (filtered osmosis) | to make 1 | gallon |

The foregoing ingredients were added to the concentrate with mixing, followed by addition of the water to make 1 gallon of sports drink. The pH of the sports drink was 2.80. Thereafter, the sports drink was separated into individual 8 oz. portions or servings, each 8 oz. portion or serving including the following amounts of ingredients:

| Ingredient | Amount | |
|---|---|---|
| Quinine | 1.5 | mg |
| Potassium | 5 | mg |
| Calcium | 2.5 | mg |
| Magnesium | 3 | mg |
| Sodium | 55 | mg |

### EXAMPLE 12

### Sports Drink Formulation

A sports drink concentrate was made, including the following ingredients:

| Ingredient | Amount | |
|---|---|---|
| Quinine sulfate, from 5 capsules (325 mg), | 1625 | mg |
| NDC 53489-0021-01, available from Mutual | | |
| Labs, Philadelphia, PA 19124 | | |
| Potassium chloride, 20% (SF) liq., NDC | 17 | ml |
| 00472-1001-16, available from Alphaderm | | |
| USPD Inc., Baltimore, MD 21244 | | |
| Calcium chloride (injection), USP 10%, | 20 | ml |
| NDC 0517-2710-25, available from | | |
| American Regent Laboratories, Inc., Shirley, | | |
| NY 11967 | | |
| Magnesium oxide, 4 tablets (400 mg. ea), | 1600 | mg |
| NDC 68585-0006-12, available from Rising | | |
| Pharmaceuticals, Inc., Paramus, NJ | | |
| Ora-plus (oral suspending agent), NDC | 15 | ml |
| 00574-0303-16, available from Paddock Co., | | |
| Minneapolis, MN 55427 | | |
| Cherry syrup (flavoring vehicle), NDC | 120 | ml |
| 00395-2662-16, available from Humco Labs, | | |
| Texarkana, TX 75501 | | |
| Water (filtered osmosis) | 8 | ml |
| Sodium chloride (table salt) | ¼ | tsp |
| Total Volume of Concentrate | 180 | ml |

The concentrate was prepared as follows. 5 capsules of quinine sulfate were emptied into a 150 ml amber prescription bottle and the gelatine caps of the capsules were discarded. 4 magnesium oxide tablets (400 mg) were crushed and combined with the quinine sulfate. 8 ml of filtered water was added, along with 15 ml Ora-Plus suspending agent and the mixture was shaken vigorously for 2 min. Then, 17 ml potassium chloride was added, along with 20 ml of calcium chloride and the mixture was shaken well for 2 min. Then, 120 of cherry syrup and ¼ tsp of sodium chloride was added and the mixture was shaken well for 2 min.

1 gallon of sports drink was prepared from 4.4 ml of the concentrate by adding the following further ingredients to the concentrate:

| Ingredient | Amount | |
|---|---|---|
| Granulated sugar | 8 | oz |
| | (240 | ml) |
| Lemon juice concentrate (liquid) | 200 | ml |
| Lime juice concentrate (liquid) | 30 | ml |
| Sodium chloride (table salt) | ¾ | tsp |
| Water (filtered osmosis) | to make 1 | gallon |

The foregoing ingredients were added to the concentrate with mixing, followed by addition of the water to make 1 gallon of sports drink. The pH of the sports drink was 2.80. Thereafter, the sports drink was separated into individual 8 oz. portions or servings, each 8 oz. portion or serving including the following amounts of ingredients:

| Ingredient | Amount | |
|---|---|---|
| Quinine | 5 | mg |
| Potassium | 5 | mg |
| Calcium | 3.5 | mg |
| Magnesium | 3 | mg |
| Sodium | 55 | mg |

### EXAMPLE 13

### Sports Drink Formulation

A sports drink concentrate was made, including the following ingredients:

| Ingredient | Amount | |
|---|---|---|
| Quinine sulfate, from 5 capsules (325 mg), | 1625 | mg |
| NDC 53489-0021-01, available from Mutual | | |
| Labs, Philadelphia, PA 19124 | | |
| Potassium chloride, 20% (SF) liq., NDC | 17 | ml |
| 00472-1001-16, available from Alphaderm | | |
| USPD Inc., Baltimore, MD 21244 | | |
| Calcium chloride (injection), USP 10%, | 28 | ml |
| NDC 0517-2710-25, available from | | |
| American Regent Laboratories, Inc., Shirley, | | |
| NY 11967 | | |
| Magnesium oxide, 4 tablets (400 mg. ea), | 1600 | mg |
| NDC 68585-0006-12, available from Rising | | |
| Pharmaceuticals, Inc., Paramus, NJ | | |
| Ora-plus (oral suspending agent), NDC | 15 | ml |
| 00574-0303-16, available from Paddock Co., | | |
| Minneapolis, MN 55427 | | |
| Cherry syrup (flavoring vehicle), NDC | 120 | ml |
| 00395-2662-16, available from Humco Labs, | | |
| Texarkana, TX 75501 | | |
| Water (filtered osmosis) | None | |
| Sodium chloride (table salt) | ¼ | tsp |
| Total Volume of Concentrate | 180 | ml |

The concentrate was prepared as follows. 5 capsules of quinine sulfate were emptied into a 150 ml amber prescription bottle and the gelatine caps of the capsules were discarded. 4 magnesium oxide tablets (400 mg) were crushed and combined with the quinine sulfate. No filtered water was added, along with 15 ml Ora-Plus suspending agent and the mixture was shaken vigorously for 2 min. Then, 17 ml potassium chloride was added, along with 28 ml of calcium chloride and the mixture was shaken well for 2 min. Then, 120 of cherry syrup and ¼ tsp of sodium chloride was added and the mixture was shaken well for 2 min.

1 gallon of sports drink was prepared from 4.4 ml of the concentrate by adding the following further ingredients to the concentrate:

| Ingredient | Amount | |
|---|---|---|
| Granulated sugar | 8 | oz |
| | (240 | ml) |
| Lemon juice concentrate (liquid) | 200 | ml |
| Lime juice concentrate (liquid) | 30 | ml |
| Sodium chloride (table salt) | ¾ | tsp |
| Water (filtered osmosis) | to make 1 | gallon |

The foregoing ingredients were added to the concentrate with mixing, followed by addition of the water to make 1 gallon of sports drink. The pH of the sports drink was 2.80. Thereafter, the sports drink was separated into individual 8 oz. portions or servings, each 8 oz. portion or serving including the following amounts of ingredients:

| Ingredient | Amount |
|---|---|
| Quinine | 5 mg |
| Potassium | 5 mg |
| Calcium | 4 mg |
| Magnesium | 3 mg |
| Sodium | 55 mg |

### EXAMPLE 14

### Sports Drink Formulation

A sports drink concentrate was made, including the following ingredients:

| Ingredient | Amount | |
|---|---|---|
| Quinine sulfate, from 5 capsules (325 mg), | 1625 | mg |
| NDC 53489-0021-01, available from Mutual | | |
| Labs, Philadelphia, PA 19124 | | |
| Potassium chloride, 20% (SF) liq., NDC | 17 | ml |
| 00472-1001-16, available from Alphaderm | | |
| USPD Inc., Baltimore, MD 21244 | | |
| Calcium chloride (injection), USP 10%, | 10 | ml |
| NDC 0517-2710-25, available from | | |
| American Regent Laboratories, Inc., Shirley, | | |
| NY 11967 | | |
| Magnesium oxide, 6 tablets (400 mg. ea), | 2400 | mg |
| NDC 68585-0006-12, available from Rising | | |
| Pharmaceuticals, Inc., Paramus, NJ | | |
| Ora-plus (oral suspending agent), NDC | 15 | ml |
| 00574-0303-16, available from Paddock Co., | | |
| Minneapolis, MN 55427 | | |
| Cherry syrup (flavoring vehicle), NDC | 120 | ml |
| 00395-2662-16, available from Humco Labs, | | |
| Texarkana, TX 75501 | | |
| Water (filtered osmosis) | 18 | ml |
| Sodium chloride (table salt) | ¼ | tsp |
| Total Volume of Concentrate | 180 | ml |

The concentrate was prepared as follows. 5 capsules of quinine sulfate were emptied into a 150 ml amber prescription bottle and the gelatine caps of the capsules were discarded. 6 magnesium oxide tablets (400 mg) were crushed and combined with the quinine sulfate. 18 ml of filtered water was added, along with 15 ml Ora-Plus suspending agent and the mixture was shaken vigorously for 2 min. Then, 17 ml potassium chloride was added, along with 10 ml of calcium chloride and the mixture was shaken well for 2 min. Then, 120 of cherry syrup and ¼ tsp of sodium chloride was added and the mixture was shaken well for 2 min.

1 gallon of sports drink was prepared from 4.4 ml of the concentrate by adding the following further ingredients to the concentrate:

| Ingredient | Amount | |
|---|---|---|
| Granulated sugar | 8 | oz |
| | (240 | ml) |
| Lemon juice concentrate (liquid) | 200 | ml |
| Lime juice concentrate (liquid) | 30 | ml |
| Sodium chloride (table salt) | ¾ | tsp |
| Water (filtered osmosis) | to make 1 | gallon |

The foregoing ingredients were added to the concentrate with mixing, followed by addition of the water to make 1 gallon of sports drink. The pH of the sports drink was 2.80. Thereafter, the sports drink was separated into individual 8 oz. portions or servings, each 8 oz. portion or serving including the following amounts of ingredients:

| Ingredient | Amount | |
|---|---|---|
| Quinine | 5 | mg |
| Potassium | 5 | mg |
| Calcium | 2.5 | mg |
| Magnesium | 3.7 | mg |
| Sodium | 55 | mg |

### EXAMPLE 15

### Sports Drink Formulation

A sports drink concentrate was made, including the following ingredients:

| Ingredient | Amount | |
|---|---|---|
| Quinine sulfate, from 5 capsules (325 mg), | 1625 | mg |
| NDC 53489-0021-01, available from Mutual | | |
| Labs, Philadelphia, PA 19124 | | |
| Potassium chloride, 20% (SF) liq., NDC | 17 | ml |
| 00472-1001-16, available from Alphaderm | | |
| USPD Inc., Baltimore, MD 21244 | | |
| Calcium chloride (injection), USP 10%, | 10 | ml |
| NDC 0517-2710-25, available from | | |
| American Regent Laboratories, Inc., Shirley, | | |
| NY 11967 | | |
| Magnesium oxide, 7 tablets (400 mg. ea), | 2800 | mg |
| NDC 68585-0006-12, available from Rising | | |
| Pharmaceuticals, Inc., Paramus, NJ | | |
| Ora-plus (oral suspending agent), NDC | 15 | ml |
| 00574-0303-16, available from Paddock Co., | | |
| Minneapolis, MN 55427 | | |
| Cherry syrup (flavoring vehicle), NDC | 120 | ml |
| 00395-2662-16, available from Humco Labs, | | |
| Texarkana, TX 75501 | | |
| Water (filtered osmosis) | 18 | ml |
| Sodium chloride (table salt) | ¼ | tsp |
| Total Volume of Concentrate | 180 | ml |

The concentrate was prepared as follows. 5 capsules of quinine sulfate were emptied into a 150 ml amber prescription bottle and the gelatine caps of the capsules were discarded. 7 magnesium oxide tablets (400 mg) were crushed and combined with the quinine sulfate. 18 ml of filtered water was added, along with 15 ml Ora-Plus suspending agent and the mixture was shaken vigorously for 2 min. Then, 17 ml potassium chloride was added, along with 10 ml of calcium chloride and the mixture was shaken well for 2 min. Then, 120 of cherry syrup and ¼ tsp of sodium chloride was added and the mixture was shaken well for 2 min.

1 gallon of sports drink was prepared from 4.4 ml of the concentrate by adding the following further ingredients to the concentrate:

| Ingredient | Amount | |
|---|---|---|
| Granulated sugar | 8 | oz |
| | (240 | ml) |
| Lemon juice concentrate (liquid) | 200 | ml |
| Lime juice concentrate (liquid) | 30 | ml |
| Sodium chloride (table salt) | ¾ | tsp |
| Water (filtered osmosis) | to make 1 | gallon |

The foregoing ingredients were added to the concentrate with mixing, followed by addition of the water to make 1 gallon of sports drink. The pH of the sports drink was 2.80. Thereafter, the sports drink was separated into individual 8 oz. portions or servings, each 8 oz. portion or serving including the following amounts of ingredients:

| Ingredient | Amount | |
|---|---|---|
| Quinine | 5 | mg |
| Potassium | 5 | mg |
| Calcium | 2.5 | mg |
| Magnesium | 4.3 | mg |
| Sodium | 55 | mg |

### EXAMPLE 16

### Sports Drink Formulation

A sports drink concentrate was made, including the following ingredients:

| Ingredient | Amount | |
|---|---|---|
| Quinine sulfate, from 5 capsules (325 mg), | 1625 | mg |
| NDC 53489-0021-01, available from Mutual | | |
| Labs, Philadelphia, PA 19124 | | |
| Potassium chloride, 20% (SF) liq., NDC | 17 | ml |
| 00472-1001-16, available from Alphaderm | | |
| USPD Inc., Baltimore, MD 21244 | | |
| Calcium chloride (injection), USP 10%, | 10 | ml |
| NDC 0517-2710-25, available from | | |
| American Regent Laboratories, Inc., Shirley, | | |
| NY 11967 | | |
| Magnesium oxide, 3 tablets (400 mg. ea), | 1200 | mg |
| NDC 68585-0006-12, available from Rising | | |
| Pharmaceuticals, Inc., Paramus, NJ | | |
| Ora-plus (oral suspending agent), NDC | 15 | ml |
| 00574-0303-16, available from Paddock Co., | | |
| Minneapolis, MN 55427 | | |
| Cherry syrup (flavoring vehicle), NDC | 120 | ml |
| 00395-2662-16, available from Humco Labs, | | |
| Texarkana, TX 75501 | | |
| Water (filtered osmosis) | 18 | ml |
| Sodium chloride (table salt) | ¼ | tsp |
| Total Volume of Concentrate | 180 | ml |

The concentrate was prepared as follows. 5 capsules of quinine sulfate were emptied into a 150 ml amber prescription bottle and the gelatine caps of the capsules were discarded. 3 magnesium oxide tablets (400 mg) were crushed and combined with the quinine sulfate. 18 ml of filtered water was added, along with 15 ml Ora-Plus suspending agent and the mixture was shaken vigorously for 2 min. Then, 17 ml potassium chloride was added, along with 10 ml of calcium chloride and the mixture was shaken well for 2 min. Then, 120 of cherry syrup and ¼ tsp of sodium chloride was added and the mixture was shaken well for 2 min.

1 gallon of sports drink was prepared from 4.4 ml of the concentrate by adding the following further ingredients to the concentrate:

| Ingredient | Amount | |
|---|---|---|
| Granulated sugar | 8 | oz |
| | (240 | ml) |
| Lemon juice concentrate (liquid) | 200 | ml |
| Lime juice concentrate (liquid) | 30 | ml |
| Sodium chloride (table salt) | ¾ | tsp |
| Water (filtered osmosis) | to make 1 | gallon |

The foregoing ingredients were added to the concentrate with mixing, followed by addition of the water to make 1 gallon of sports drink. The pH of the sports drink was 2.80. Thereafter, the sports drink was separated into individual 8 oz. portions or servings, each 8 oz. portion or serving including the following amounts of ingredients:

| Ingredient | Amount | |
|---|---|---|
| Quinine | 5 | mg |
| Potassium | 5 | mg |
| Calcium | 2.5 | mg |
| Magnesium | 1.85 | mg |
| Sodium | 55 | mg |

### EXAMPLE 17

### Sports Drink Formulation

A sports drink concentrate was made, including the following ingredients:

| Ingredient | Amount | |
|---|---|---|
| Quinine sulfate, from 5 capsules (325 mg), | 1625 | mg |
| NDC 53489-0021-01, available from Mutual | | |
| Labs, Philadelphia, PA 19124 | | |
| Potassium chloride, 20% (SF) liq., NDC | 17 | ml |
| 00472-1001-16, available from Alphaderm | | |
| USPD Inc., Baltimore, MD 21244 | | |
| Calcium chloride (injection), USP 10%, | 10 | ml |
| NDC 0517-2710-25, available from | | |
| American Regent Laboratories, Inc., Shirley, | | |
| NY 11967 | | |
| Magnesium oxide, 4 tablets (400 mg. ea), | 1600 | mg |
| NDC 68585-0006-12, available from Rising | | |
| Pharmaceuticals, Inc., Paramus, NJ | | |
| Ora-plus (oral suspending agent), NDC | 15 | ml |
| 00574-0303-16, available from Paddock Co., | | |
| Minneapolis, MN 55427 | | |
| Cherry syrup (flavoring vehicle), NDC | 120 | ml |
| 00395-2662-16, available from Humco Labs, | | |
| Texarkana, TX 75501 | | |
| Water (filtered osmosis) | 18 | ml |
| Sodium chloride (table salt) | ¼ | tsp |
| Total Volume of Concentrate | 180 | ml |

The concentrate was prepared as follows. 5 capsules of quinine sulfate were emptied into a 150 ml amber prescription bottle and the gelatine caps of the capsules were discarded. 4 magnesium oxide tablets (400 mg) were crushed and combined with the quinine sulfate. 18 ml of filtered water was added, along with 15 ml Ora-Plus suspending agent and the mixture was shaken vigorously for 2 min. Then, 17 ml potassium chloride was added, along with 10 ml of calcium chloride and the mixture was shaken well for 2 min. Then, 120 of cherry syrup and ¼ tsp of sodium chloride was added and the mixture was shaken well for 2 min.

1 gallon of sports drink was prepared from 4.4 ml of the concentrate by adding the following further ingredients to the concentrate:

The foregoing ingredients were added to the concentrate with mixing, followed by addition of the water to make 1 gallon of sports drink. Thereafter, the sports drink was separated into individual 8 oz. portions or servings. 1/16^{th} of a teaspoon of sodium bicarbonate was added to each portion to bring the pH of each portion of the sports drink to 3.92, each 8 oz. portion or serving including the following amounts of ingredients:

| Ingredient | Amount | |
|---|---|---|
| Quinine | 2.5 | mg |
| Potassium | 5 | mg |
| Calcium | 2.5 | mg |
| Magnesium | 3 | mg |
| Sodium | 55 | mg |

### EXAMPLE 18

### Sports Drink Formulation

A sports drink concentrate was made, including the following ingredients:

| Ingredient | Amount | |
|---|---|---|
| Quinine sulfate, from 5 capsules (325 mg), | 1625 | mg |
| NDC 53489-0021-01, available from Mutual | | |
| Labs, Philadelphia, PA 19124 | | |
| Potassium chloride, 20% (SF) liq., NDC | 17 | ml |
| 00472-1001-16, available from Alphaderm | | |
| USPD Inc., Baltimore, MD 21244 | | |
| Calcium chloride (injection), USP 10%, | 10 | ml |
| NDC 0517-2710-25, available from | | |
| American Regent Laboratories, Inc., Shirley, | | |
| NY 11967 | | |
| Magnesium oxide, 4 tablets (400 mg. ea), | 1600 | mg |
| NDC 68585-0006-12, available from Rising | | |
| Pharmaceuticals, Inc., Paramus, NJ | | |
| Ora-plus (oral suspending agent), NDC | 15 | ml |
| 00574-0303-16, available from Paddock Co., | | |
| Minneapolis, MN 55427 | | |
| Cherry syrup (flavoring vehicle), NDC | 120 | ml |
| 00395-2662-16, available from Humco Labs, | | |
| Texarkana, TX 75501 | | |
| Water (filtered osmosis) | 18 | ml |
| Sodium chloride (table salt) | ¼ | tsp |
| Total Volume of Concentrate | 180 | ml |

The concentrate was prepared as follows. 5 capsules of quinine sulfate were emptied into a 150 ml amber prescription bottle and the gelatine caps of the capsules were discarded. 4 magnesium oxide tablets (400 mg) were crushed and combined with the quinine sulfate. 18 ml of filtered water was added, along with 15 ml Ora-Plus suspending agent and the mixture was shaken vigorously for 2 min. Then, 17 ml potassium chloride was added, along with 10 ml of calcium chloride and the mixture was shaken well for 2 min. Then, 120 of cherry syrup and ¼ tsp of sodium chloride was added and the mixture was shaken well for 2 min.

1 gallon of sports drink was prepared from 4.4 ml of the concentrate by adding the following further ingredients to the concentrate:

| Ingredient | Amount | |
|---|---|---|
| Granulated sugar | 10 | oz |
| | (240 | ml) |
| 2 packets of punch flavored powder, 0.15 | 0.30 | oz |
| oz (4.25 g) ea., containing citric acid | (8.5 | g) |
| maltodextrin, artificial flavor, Red 40, and | | |
| ascorbic acid, Inter-American Products, Inc., | | |
| Cincinnati, OH 45202. | | |
| Sodium chloride (table salt) | ¾ | tsp |
| Water (filtered osmosis) | to make 1 | gallon |

The foregoing ingredients were added to the concentrate with mixing, followed by addition of the water to make 1 gallon of sports drink. Thereafter, the sports drink was separated into individual 8 oz. portions or servings. ⅛^{th} of a teaspoon of sodium bicarbonate was added to each portion to bring the pH of each portion of the sports drink to 5.2, each 8 oz. portion or serving including the following amounts of ingredients:

| Ingredient | Amount | |
|---|---|---|
| Quinine | 2.5 | mg |
| Potassium | 5 | mg |
| Calcium | 2.5 | mg |
| Magnesium | 3 | mg |
| Sodium | 55 | mg |

### EXAMPLE 19

### Sports Drink Formulation

A sports drink concentrate was made, including the following ingredients:

| Ingredient | Amount | |
|---|---|---|
| Quinine sulfate, from 5 capsules (325 mg), | 1625 | mg |
| NDC 53489-0021-01, available from Mutual | | |
| Labs, Philadelphia, PA 19124 | | |
| Potassium chloride, 20% (SF) liq., NDC | 17 | ml |
| 00472-1001-16, available from Alphaderm | | |
| USPD Inc., Baltimore, MD 21244 | | |
| Calcium chloride (injection), USP 10%, | 10 | ml |
| NDC 0517-2710-25, available from | | |
| American Regent Laboratories, Inc., Shirley, | | |
| NY 11967 | | |
| Magnesium oxide, 4 tablets (400 mg. ea), | 1600 | mg |
| NDC 68585-0006-12, available from Rising | | |
| Pharmaceuticals, Inc., Paramus, NJ | | |
| Ora-plus (oral suspending agent), NDC | 15 | ml |
| 00574-0303-16, available from Paddock Co., | | |
| Minneapolis, MN 55427 | | |
| Cherry syrup (flavoring vehicle), NDC | 120 | ml |
| 00395-2662-16, available from Humco Labs, | | |
| Texarkana, TX 75501 | | |
| Water (filtered osmosis) | 18 | ml |
| Sodium chloride (table salt) | ¼ | tsp |
| Total Volume of Concentrate | 180 | ml |

The concentrate was prepared as follows. 5 capsules of quinine sulfate were emptied into a 150 ml amber prescription bottle and the gelatine caps of the capsules were discarded. 4 magnesium oxide tablets (400 mg) were crushed and combined with the quinine sulfate. 18 ml of filtered water was added, along with 15 ml Ora-Plus suspending agent and the mixture was shaken vigorously for 2 min. Then, 17 ml potassium chloride was added, along with 10 ml of calcium chloride and the mixture was shaken well for 2 min. Then, 120 of cherry syrup and ¼ tsp of sodium chloride was added and the mixture was shaken well for 2 min.

1 gallon of sports drink was prepared from 4.4 ml of the concentrate by adding the following further ingredients to the concentrate:

| Ingredient | Amount | |
|---|---|---|
| Granulated sugar | 10 | oz |
| | (240 | ml) |
| 2 packets of punch flavored powder, 0.15 | 0.30 | oz |
| oz (4.25 g) ea., containing citric acid | (8.5 | g) |
| maltodextrin, artificial flavor, Red 40, and | | |
| ascorbic acid, Inter-American Products, Inc., | | |
| Cincinnati, OH 45202. | | |
| Sodium chloride (table salt) | ¾ | tsp |
| Water (filtered osmosis) | to make 1 | gallon |

The foregoing ingredients were added to the concentrate with mixing, followed by addition of the water to make 1 gallon of sports drink. Thereafter, the sports drink was separated into individual 8 oz. portions or servings. 3/16^{th} of a teaspoon of sodium bicarbonate was added to each portion to bring the pH of each portion of the sports drink to 6.17 each 8 oz. portion or serving including the following amounts of ingredients:

| Ingredient | Amount | |
|---|---|---|
| Quinine | 2.5 | mg |
| Potassium | 5 | mg |
| Calcium | 2.5 | mg |
| Magnesium | 3 | mg |
| Sodium | 55 | mg |

### EXAMPLE 20

### Sports Drink Formulation

A sports drink concentrate was made, including the following ingredients:

| Ingredient | Amount | |
|---|---|---|
| Quinine sulfate, from 5 capsules (325 mg), | 1625 | mg |
| NDC 53489-0021-01, available from Mutual | | |
| Labs, Philadelphia, PA 19124 | | |
| Potassium chloride, 20% (SF) liq., NDC | 17 | ml |
| 00472-1001-16, available from Alphaderm | | |
| USPD Inc., Baltimore, MD 21244 | | |
| Calcium chloride (injection), USP 10%, | 10 | ml |
| NDC 0517-2710-25, available from | | |
| American Regent Laboratories, Inc., Shirley, | | |
| NY 11967 | | |
| Magnesium oxide, 4 tablets (400 mg. ea), | 1600 | mg |
| NDC 68585-0006-12, available from Rising | | |
| Pharmaceuticals, Inc., Paramus, NJ | | |
| Ora-plus (oral suspending agent), NDC | 15 | ml |
| 00574-0303-16, available from Paddock Co., | | |
| Minneapolis, MN 55427 | | |
| Cherry syrup (flavoring vehicle), NDC | 120 | ml |
| 00395-2662-16, available from Humco Labs, | | |
| Texarkana, TX 75501 | | |
| Water (filtered osmosis) | 18 | ml |
| Sodium chloride (table salt) | ¼ | tsp |
| Total Volume of Concentrate | 180 | ml |

The concentrate was prepared as follows. 5 capsules of quinine sulfate were emptied into a 150 ml amber prescription bottle and the gelatine caps of the capsules were discarded. 4 magnesium oxide tablets (400 mg) were crushed and combined with the quinine sulfate. 18 ml of filtered water was added, along with 15 ml Ora-Plus suspending agent and the mixture was shaken vigorously for 2 min. Then, 17 ml potassium chloride was added, along with 10 ml of calcium chloride and the mixture was shaken well for 2 min. Then, 120 of cherry syrup and ¼ tsp of sodium chloride was added and the mixture was shaken well for 2 min.

1 gallon of sports drink was prepared from 4.4 ml of the concentrate by adding the following further ingredients to the concentrate:

| Ingredient | Amount | |
|---|---|---|
| Granulated sugar | 10 | oz |
| | (240 | ml) |
| 2 packets of punch flavored powder, 0.15 | 0.30 | oz |
| oz (4.25 g) ea., containing citric acid | (8.5 | g) |
| maltodextrin, artificial flavor, Red 40, and | | |
| ascorbic acid, Inter-American Products, Inc., | | |
| Cincinnati, OH 45202. | | |
| Sodium chloride (table salt) | ¾ | tsp |
| Water (filtered osmosis) | to make 1 | gallon |

The foregoing ingredients were added to the concentrate with mixing, followed by addition of the water to make 1 gallon of sports drink. Thereafter, the sports drink was separated into individual 8 oz. portions or servings. ¼^{th} of a teaspoon of sodium bicarbonate was added to each portion to bring the pH of each portion of the sports drink to 7.07 each 8 oz. portion or serving including the following amounts of ingredients:

| Ingredient | Amount | |
|---|---|---|
| Quinine | 2.5 | mg |
| Potassium | 5 | mg |
| Calcium | 2.5 | mg |
| Magnesium | 3 | mg |
| Sodium | 55 | mg |

### EXAMPLE 21

### Muscle Cramping Study #2

The present study focused on the effect of small doses of quinine, magnesium, and calcium, delivered via a sports drink of the present invention, on the number and severity of muscular cramps experienced by athletes during high school football games.

55 male high school athletes (ages 16-18) participated in a double blind study testing the effect of the sports drink of EXAMPLE 7, which contained small doses of quinine, along with magnesium, calcium, salts, sugar and flavoring, as described above. Informed parental consent was obtained from all athletes under the age of 18. The study was conducted in two consecutive weeks during two consecutive football games. This two week test allowed each athlete to consume both the test drink and a control drink within the two week test.

The 55 athletes played on 5 different teams. Each athlete was given 8 oz of either the test drink of EXAMPLE 7, or a control drink without quinine or magnesium, 45 minutes prior to game time. The athletes were not aware of which drink each athlete consumed. Ambient temperature at game time for week one was 63° F. and was 59° F. for week two. Each athlete was interviewed within 15 minutes after the game and asked questions about number and severity of cramps experienced during the game. 5 athletes had consumed ibuprofen prior to the game and 3 were taking allergy medications. Athletes were allowed to consume water as they normally would during the game during both trial periods. The average time played by each player was over 3 quarters, with most athletes playing both offense and defense.

A total of 4 cramps were experienced by 3 athletes who had consumed the test drink. The severity of cramping ranged from 2-6 on a 0-10 scale. Cramps were treated at the time of onset with rest, stretching and consumption of water. A total of 14 cramps were experienced by 9 athletes who had consumed the control drink. The severity of cramping ranged from 1-6 on a 0-10 scale. Cramps were treated as described above.

Thus, a decrease in the number of total cramps was observed when the athletes consumed the test drink with quinine and magnesium when compared to the control drink with only salt, sugar and water.

### EXAMPLE 21

### Muscle Cramping Study #3

The present study focused on the effect of small doses of quinine, magnesium, and calcium, delivered via a sports drink of the present invention, on the number and severity of muscular cramps experienced by athletes while playing lacrosse.

Lacrosse is a game which involves considerable running, and cramping is frequently a problem, particularly when the weather is warmer and/or when the game is played in relatively high grass.

11 lacrosse midfielder and offensive players were allowed to drink 8 oz of a control drink, which approximated Gatorade® sports drink and included sodium, potassium, and sucrose, prior to the game. (Gatorade® is a registered trademark of Stokely-Van Camp, Inc. of Chicago, Ill.). During the game, the players were encouraged to drink the control drink to manage their dehydration. The average consumption was 17 oz. The 11 players consumed the control drink for two games, and experienced a total of 8 cramps with an average severity of 7 on a 1-10 scale. The ambient temperature for these two games was 55° F. and 59° F.

11 players, 10 of whom were the same players as in the foregoing control group, were allowed to consume the sports drink of EXAMPLE 7, which included quinine, magnesium, calcium, salts, sugar and flavoring, as described above, in two separate games two weeks later. The athletes each consumed 8 oz of the sports drink prior to each of the games. These 11 players suffered a total only 2 cramps with an average severity of 3 on a 1-10 scale. The ambient temperature for these two games was 61° F. and 63° F.

While this was a small study, it gave indications that small amounts of quinine coupled with magnesium and calcium seemed to decrease muscle cramping in athletes who are potentially prone to muscle cramping.

While this invention has been described as having a preferred design, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

1. A liquid composition for use as a sports drink, comprising:
water;
at least one electrolyte; and
quinine, in an amount of between 0.5 and 4.5 mg/8 oz.

2. The composition of claim 1, comprising quinine in an amount of between 1.0 and 4.0 mg/8 oz.

3. The composition of claim 1, wherein said at least one electrolyte comprises magnesium in an amount of between 0.5 and 25 mg/8 oz.

4. The composition of claim 1, wherein said at least one electrolyte comprises calcium in an amount of between 0.5 and 25 mg/8 oz.

5. The composition of claim 1, having a pH of between 5.0 and 7.5.

6. The composition of claim 1, further comprising sodium chloride.

7. The composition of claim 1, further comprising at least one of a flavoring agent and a suspending agent.

8. A liquid composition for use as a sports drink, comprising:
water;
quinine; and
magnesium, in an amount of between 0.5 and 25 mg/8 oz.

9. The composition of claim 8, comprising magnesium in an amount of between 1.5 and 5 mg/8 oz.

10. The composition of claim 8, comprising quinine in an amount of between 0.5 and 10 mg/8 oz.

11. The composition of claim 10, wherein said at least one electrolyte comprises calcium in an amount of between 0.5 and 25 mg/8 oz.

12. The composition of claim 8, having a pH of between 5.0 and 7.5.

13. The composition of claim 8, further comprising sodium chloride.

14. The composition of claim 8, further comprising at least one of a flavoring agent and a suspending agent.

15. A liquid composition for use as a sports drink, comprising:
water;
quinine; and
calcium, in an amount of between 0.5 and 25 mg/8 oz.

16. The composition of claim 15, comprising calcium in an amount of between 1.5 and 5 mg/8 oz.

17. The composition of claim 15, comprising quinine in an amount of between 0.5 and 10 mg/8 oz.

18. The composition of claim 17, comprising magnesium in an amount of between 0.5 and 25 mg/8 oz.

19. The composition of claim 15, having a pH of between 5.0 and 7.5.

20. The composition of claim 15, further comprising sodium chloride.

21. The composition of claim 15, further comprising at least one of a flavoring agent and a suspending agent.

22. A liquid composition for use as a sports drink, comprising:
water;
at least one electrolyte;
quinine; and
said composition having a pH of between 5.0 and 7.5.

23. The composition of claim 22, comprising quinine in an amount of between 0.5 and 10 mg/8 oz.

24. The composition of claim 22, comprising magnesium in an amount of between 0.5 and 25 mg/8 oz.

25. The composition of claim 22, wherein said at least one electrolyte comprises calcium in an amount of between 0.5 and 25 mg/8 oz.

26. The composition of claim 22, further comprising sodium chloride.

27. The composition of claim 22, further comprising at least one of a flavoring agent and a suspending agent.
